(19) United States
(12) Patent Application Publication
(10) Pub. No.: US 2025/0033666 A1
(43) Pub. Date: Jan. 30, 2025

(54) SYSTEM AND METHOD FOR CONTROLLING VEHICLE

(71) Applicants: Hyundai Motor Company, Seoul (KR); Kia Corporation, Seoul (KR)

(72) Inventor: Su Young Choi, Seoul (KR)

(21) Appl. No.: 18/533,314

(22) Filed: Dec. 8, 2023

(30) Foreign Application Priority Data
Jul. 28, 2023 (KR) 10-2023-0099153

(51) Int. Cl. B60W 60/00; B60W 30/09; B60W 30/095

(52) U.S. Cl. CPC B60W 60/0011; B60W 30/09; B60W 30/0953; B60W 30/0956; B60W 60/0015; B60W 2552/30

(57) ABSTRACT

The present disclosure relates to a system and a method for controlling a vehicle, and the system includes a vehicle control device included in the vehicle, and a control center. The vehicle control device transmits first information including at least one of information on the vehicle or information related to travel of the vehicle, or any combination to the control center based on identifying an external object causing an operation of the vehicle to be stopped within a first travel path while the vehicle is operated along the first travel path. The control center changes the first travel path to generate a second travel path based on reception of the first information, and transmits second information including the second travel path to the vehicle control device based on the generation of the second travel path.

### CROSS-REFERENCE TO RELATED APPLICATION

This application claims the benefit of priority to Korean Patent Application No. 10-2023-0099153, filed in the Korean Intellectual Property Office on Jul. 28, 2023, the entire contents of which are incorporated herein by reference.

### TECHNICAL FIELD

The present disclosure relates to a system and a method for controlling a vehicle, and more particularly, to a technology for changing a travel path of a vehicle while the vehicle is in operation.

### BACKGROUND

An autonomous vehicle may include an intelligent vehicle that improves safety and convenience of travel by recognizing a travel environment and assisting driving or traveling by itself.

Based on path planning used in such an autonomous vehicle, a method may be provided for modifying a path when the travel stops as an object that interferes with the travel of the autonomous vehicle is identified while the autonomous vehicle is traveling using the specified path.

Levels of autonomous driving are classified into level 0 to level 5. If the level of the autonomous driving is the level 0 to the level 2, autonomous driving of assisting a driver or being partially automated driving assistance may be performed, and if the level of the autonomous driving is the level 3 to the level 5, conditional autonomous driving, advanced autonomous driving, or fully autonomous driving may be performed.

In particular, if the level of the autonomous driving is the level 4 or higher, operation of the autonomous vehicle is controlled by components included in the autonomous vehicle, so that the method for modifying the travel path of the autonomous vehicle in a state may not be controlled by a passenger.

### SUMMARY

The following summary presents a simplified summary of certain features. The summary is not an extensive overview and is not intended to identify key or critical elements.

An aspect of the present disclosure may provide a system and a method for controlling a vehicle that operate the vehicle along a second travel path different from a first travel path based on identifying an external object that causes the operation of the vehicle to be stopped while the vehicle is operating along the first travel path.

Another aspect of the present disclosure may provide a system and a method for controlling a vehicle that provide a travel path where the vehicle is operated by bypassing an obstacle if a center line invading travel is necessary because of the obstacle on a single-lane one-way road or a dual-lane two-way road.

Another aspect of the present disclosure provides a system and a method for controlling a vehicle that improve stability of the vehicle by providing a new travel path to bypass an object located in front of the vehicle when a distance between the vehicle and the object located in front of the vehicle is small.

The technical problems to be solved by the present disclosure are not limited to the aforementioned problems, and any other technical problems not mentioned herein will be clearly understood from the following description by those skilled in the art to which the present disclosure pertains.

A vehicle may comprise: a communication interface; a vehicle control device; and a controller, wherein the controller is configured to: transmit, to a device via the communication interface, first information indicating a first autonomous driving path of the vehicle; receive, based on an external object causing an adjustment of the first autonomous driving path while the vehicle is driving along the first autonomous driving path, second information indicating a second autonomous driving path, wherein the second autonomous driving path is adjusted based on the first autonomous driving path; and based on a determination of whether the second autonomous driving path is feasible for an autonomous driving adjustment of the vehicle: perform, by the vehicle control device, the autonomous driving adjustment of the vehicle; or transmit, to the device, information indicating that the second autonomous driving path is infeasible for the vehicle.

The controller may be configured to: after receiving the second information, generate the second autonomous driving path based on a plurality of changed points obtained by changing locations of a first plurality of points included in the first autonomous driving path, wherein a direction of the changing locations of the first plurality of points is perpendicular to a direction of the first autonomous driving path.

The controller may be configured to: identify, among a plurality of changed points included in the second autonomous driving path, a first changed point where the vehicle is to be operated, a second changed point where the vehicle is to be operated after the first changed point, and a third changed point where the vehicle is to be operated after the second changed point, wherein the plurality of changed points are obtained by changing locations of a first plurality of points included in the first autonomous driving path; identify a radius of curvature based on at least one of: the first changed point, the second changed point, or the third changed point; and determine whether the vehicle is able to be operated along the second autonomous driving path based on at least one of: the radius of curvature, or motion characteristic information of the vehicle.

At least one of the controller or the vehicle control device may be configured to: generate a third autonomous driving path by changing locations of the plurality of changed points based on the radius of curvature being smaller than a minimum turning radius of the vehicle.

The controller may be configured to: receive the second information by receiving, by the vehicle control device, the second information indicating, the second autonomous driving path that comprises the plurality of changed points, based on the radius of curvature being greater than a minimum turning radius of the vehicle.

At least one of the controller or the vehicle control device may be configured to: obtain a virtual travel lane based on a specified offset applied to a width of the vehicle; and determine a possibility of collision between the external object and the vehicle based on whether the external object is identified within the virtual travel lane.

The controller may be configured to: determine, based on the possibility of collision between the external object and the vehicle, a third autonomous driving path by changing locations of a plurality of changed points, wherein the plurality of changed points are obtained by changing locations of a first plurality of points included in the first autonomous driving path; and transmit, to the vehicle control device, third information indicating the third autonomous driving path.

The controller may be configured to: transmit, to the vehicle control device and based on the external object not being identified within the virtual travel lane, the second information indicating the second autonomous driving path.

At least one of the vehicle control device or the controller may be configured to: compare a first coordinate system associated with the second autonomous driving path with a second coordinate system associated with the vehicle control device, control, based on the first coordinate system and the second coordinate system being the same, the vehicle along the second autonomous driving path, and based on a difference between the first coordinate system and the second coordinate system: convert the first coordinate system associated with the second autonomous driving path, and control, based on converting the first coordinate system, the vehicle along the second autonomous driving path.

At least one of the vehicle control device or the controller may be configured to: transmit, to the device that is associated with a control center, a driving disturbance signal indicating that the vehicle is not able to be operated along the second autonomous driving path, and receive, based on the driving disturbance signal, a third autonomous driving path obtained by changing locations of the plurality of changed points.

The first information may comprise information of the vehicle comprising at least one of: a specification of the vehicle, or motion characteristic information of the vehicle, and wherein the first information comprises information related to driving of the vehicle comprising at least one of: a surrounding environment of the vehicle, a location of the vehicle, a speed of the vehicle, the first autonomous driving path, a first plurality of points included in the first autonomous driving path, or a signal indicating that the vehicle is not able to be operated along the first autonomous driving path.

A method may comprise: transmitting, from a vehicle to a device, first information indicating a first autonomous driving path of the vehicle; receiving, by the vehicle and based on an external object causing an adjustment of the first autonomous driving path while the vehicle is driving along the first autonomous driving path, second information indicating a second autonomous driving path, wherein the second autonomous driving path is adjusted based on the first autonomous driving path; and based on a determination of whether the second autonomous driving path is feasible for an autonomous driving adjustment of the vehicle: performing the autonomous driving adjustment of the vehicle; or transmitting, to the device, information indicating that the second autonomous driving path is infeasible for the vehicle.

The method may further comprise: generating the second autonomous driving path based on a plurality of changed points obtained by changing locations of a first plurality of points included in the first autonomous driving path.

The method may further comprise: identifying, among a plurality of changed points included in the second autonomous driving path, a first changed point where the vehicle is to be operated, a second changed point where the vehicle is to be operated after the first changed point, and a third changed point where the vehicle is to be operated after the second changed point, wherein the plurality of changed points are obtained by changing locations of a first plurality of points included in the first autonomous driving path; identifying a radius of curvature based on at least one of: the first changed point, the second changed point, or the third changed point; and determining whether the vehicle is able to be operated along the second autonomous driving path based on at least one of: the radius of curvature, or motion characteristic information of the vehicle.

The method may further comprise: generating a third autonomous driving path by changing locations of the plurality of changed points based on the radius of curvature being smaller than a minimum turning radius of the vehicle.

The receiving the second information may comprise receiving, by a vehicle control device of the vehicle, the second information, indicating the second autonomous driving path that comprises the plurality of changed points, based on the radius of curvature being greater than a minimum turning radius of the vehicle.

The method may further comprise: obtaining a virtual travel lane based on a specified offset applied to a width of the vehicle; and determining a possibility of collision between the external object and the vehicle based on whether the external object is identified within the virtual travel lane.

The method may further comprise: determining, based on the possibility of collision between the external object and the vehicle, a third autonomous driving path by changing locations of a plurality of changed points, wherein the plurality of changed points are obtained by changing locations of a first plurality of points included in the first autonomous driving path; and transmitting, to a vehicle control device of the vehicle, third information indicating the third autonomous driving path.

The method may further comprise: transmitting, to a vehicle control device of the vehicle and based on the external object not being identified within the virtual travel lane, the second information indicating the second autonomous driving path.

The method may further comprise: comparing a first coordinate system associated with the second autonomous driving path with a second coordinate system associated with a vehicle control device of the vehicle; converting, based on a difference between the first coordinate system and the second coordinate system, the first coordinate system associated with the second autonomous driving path; and controlling, based on the converting, the vehicle along the second autonomous driving path.

The device (e.g., a server, a relay, etc.) may be associated with a control center and communicate with the vehicle via wireless communication. The device may have granted with an authority and policy (e.g., for generating an autonomous driving path) that are not available for the autonomous driving system of the vehicle. For example, the vehicle may not generate an alternative autonomous driving path that causes the vehicle to violate traffic laws and driving rules (e.g. crossing the center lane of a road, increasing the vehicle speed over a specific speed, etc.) while the device associated with the control center may generate such an alternative autonomous driving path that causes the vehicle to violate traffic laws and driving rules based on additional traffic data (e.g., additional traffic information regarding other vehicles and obstacles).

These and other features and advantages are described in greater detail below.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of a block diagram of a vehicle control system;

FIG. 2 shows an example of obtaining a second travel path by changing locations of a first plurality of points included in a first travel path;

FIG. 3 shows an example of obtaining a radius of curvature to determine whether a vehicle is able to be operated;

FIG. 4 shows an example of identifying a possibility of collision between a vehicle with an external object;

FIG. 5 shows an example of a signal flow diagram of a control center and a vehicle control device;

FIG. 6 shows an example of a flowchart related to operations of a vehicle control device;

FIG. 7 shows an example of a flowchart related to operations of a control center; and

FIG. 8 illustrates a computing system.

### DETAILED DESCRIPTION

Hereinafter, some examples and aspects of the present disclosure will be described in detail with reference to the exemplary drawings. In adding the reference numerals to the components of each drawing, it should be noted that the identical or equivalent component is designated by the identical numeral even when they are displayed on other drawings. Further, in describing various examples of the present disclosure, a detailed description of the related known configuration or function may be omitted when it is determined that it interferes with the understanding of the gist of the present disclosure.

In describing the components according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

An autonomous vehicle may be operated based on travel levels from 0 to 5 levels. If the level is the level 4 or higher among the travel levels from the 0 to 5 levels, there may be cases where operation is infeasible (e.g., impossible) because of an external object on a travel path of the autonomous vehicle while the autonomous vehicle is in operation. If the operation of the autonomous vehicle is infeasible, it may be necessary to modify the travel path and operate the autonomous vehicle along a new travel path, and various methods for acquiring the new travel path are being studied.

A vehicle control device to be described below may be disposed in the autonomous vehicle or a vehicle to control the autonomous vehicle or the vehicle, and a control center may perform various operations based on reception of information (or a signal) transmitted from the autonomous vehicle or the vehicle.

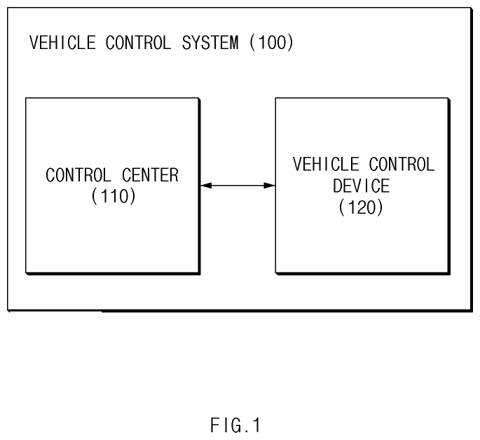

Hereinafter, various examples of the present disclosure will be described in detail with reference to FIGS. 1 to 8.

FIG. 1 shows an example of a block diagram of a vehicle control system.

Referring to FIG. 1, a vehicle control device 120 may be implemented inside or outside the vehicle, and some of components included in the vehicle control device 120 may be implemented inside or outside the vehicle. In this regard, the vehicle control device 120 may be integrally formed with internal control units of the vehicle, or may be implemented as a separate device and connected to the control units of the vehicle by separate connection interface.

Referring to FIG. 1, a vehicle control system 100 may include at least one of a control center 110 or the vehicle control device 120, or any combination thereof. The control center 110 and the vehicle control device 120 may be in communication with each other by establishing a communication link. For example, the control center 110 and the vehicle control device 120 may transmit and receive a signal (or information) with each other via wireless or wired connection. The vehicle control device 120 may include a controller (e.g., a processor and memory) and a device for controlling the driving of the vehicle (e.g., controlling the steering, speed, etc.). In the present disclosure, a vehicle control device may be the device for controlling the driving of the vehicle or may include at least the controller and the device for controlling the driving of the vehicle.

The vehicle control device 120 may be included in the vehicle. For example, the vehicle may be operated in a state in which intervention of a driver is unnecessary. For example, the state in which the intervention of the driver is unnecessary may include a state in which the operation level of the vehicle (e.g., including the level 0 to the level 5) is the level 4 or higher.

The vehicle control device 120 may identify that the vehicle is in operation along a first travel path. For example, the vehicle control device 120 may identify that the vehicle is in operation along a first plurality of points included in the first travel path. The vehicle control device 120 may identify the external object that causes the vehicle to stop operating within the first travel path while the vehicle is in operation sequentially along the first plurality of points. For example, the external object may include at least one of an external vehicle different from the vehicle including the vehicle control device 120, an obstacle including a thing, or a pedestrian, or any combination thereof.

For example, the first plurality of points may include points at which the vehicle is to be operated. The first plurality of points may include points indicating locations obtained by segmenting a specified distance (e.g., about 50 m) in which the vehicle is to be operated. For example, the first plurality of points may include points indicating locations obtained by segmenting the specified distance in which the vehicle is to be operated based on a specified spacing (e.g., about 1 m). For example, the first travel path may be expressed in a form of a line in which the first plurality of points are sequentially connected to each other.

The vehicle control device 120 may transmit first information including at least one of information on the vehicle or information related to the travel of the vehicle, or any combination thereof to the control center 110 based on the identification of the external object that causes the vehicle to stop operating within the first travel path.

For example, the information on the vehicle may include at least one of a specification of the vehicle or motion characteristic information of the vehicle, or any combination thereof.

For example, the information related to the travel of the vehicle may include a surrounding environment of the vehicle, a location of the vehicle, a speed of the vehicle, the first travel path, the first plurality of points, and/or a signal indicating that the vehicle is not able to operate along the first travel path.

For example, the surrounding environment of the vehicle may include image information obtained via an imaging device included in the vehicle. For example, the imaging device may include at least one of a camera or a light detection and ranging (LiDAR), or any combination thereof.

For example, the first plurality of points may be included in the first travel path.

For example, the signal indicating that the vehicle is not able to operate along the first travel path may be generated based on the identification, by the vehicle control device 120, of the external object that causes the vehicle to stop operating within the first travel path.

For example, the specification of the vehicle may include at least one of a length, a width, and a height of the vehicle, or a distance between wheels disposed in the vehicle, or any combination thereof.

For example, the motion characteristic information of the vehicle may include a minimum turning radius of the vehicle.

The control center 110 may change locations of the first plurality of points included in the first travel path based on the reception of the first information from the vehicle control device 120. For example, the control center 110 may generate (or obtain) a second travel path for bypassing the external object by changing the locations of the first plurality of points. For example, the control center 110 may generate the second travel path based on a second plurality of points that have changed the locations of the first plurality of points. Hereinafter, an operation of generating the travel path may include an operation of obtaining the travel path.

The control center 110 may transmit second information including the second travel path to the vehicle control device 120 based on the generation of the second travel path. For example, the second travel path may include the second plurality of points including points the same as or different from the first plurality of points.

For example, the second plurality of points may include points obtained by moving the first plurality of points included in the first travel path in a direction perpendicular to the first travel path. For example, the second plurality of points may be obtained based on the movement of each of the first plurality of points depending on a distance between the external object and each of the first plurality of points.

The control center 110 may transmit the second information including the second travel path to the vehicle control device 120 based on the obtaining of the second travel path including the second plurality of points.

The vehicle control device 120 may receive second information including the second travel path from the control center 110. The vehicle control device 120 may identify the second plurality of points included in the second information based on the reception of the second information. The vehicle control device 120 may cause the vehicle including the vehicle control device 120 to be operated sequentially at locations of the second plurality of points. Alternatively, the vehicle control device 120 may operate by directly controlling the vehicle to the locations of the second plurality of points.

The vehicle control device 120 may convert a first coordinate system included in the second travel path into a second coordinate system different from the first coordinate system, based on the reception of the second information transmitted from the control center 110.

The vehicle control device 120 may compare a first coordinate system included in the second travel path received from the control center 110 with a second coordinate system used in the vehicle control device 120.

For example, the vehicle control device 120 may operate the vehicle along the second travel path based on a condition that the first coordinate system and the second coordinate system are the same.

For example, the vehicle control device 120 may convert the first coordinate system included in the second travel path into the second coordinate system, based on a condition that the first coordinate system and the second coordinate system are different.

For example, the vehicle control device 120 may operate the vehicle along the second travel path including the second coordinate system.

For example, the first coordinate system may include a world geodetic system (WGS) 84. For example, the first coordinate system may include a world map coordinate system. For example, the first coordinate system may include a global coordinate system. For example, the second coordinate system may include a local coordinate system. However, aspects of the present disclosure are not limited thereto.

The vehicle control device 120 may cause the vehicle to operate along the second travel path based on the second travel path converted to the second coordinate system.

At least one of the control center 110 or the vehicle control device 120 may determine whether the vehicle is able to be operated based on the second plurality of points. For example, at least one of the control center 110 or the vehicle control device 120 may determine whether the vehicle is able to be operated along the second travel path.

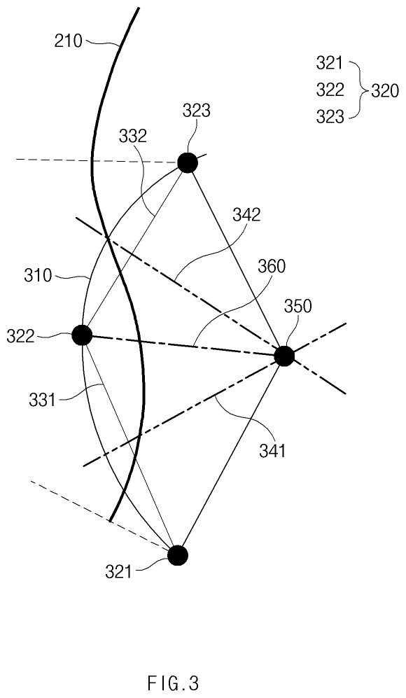

For example, at least one of the control center 110 or the vehicle control device 120 may compare a radius of curvature formed by some of the second plurality of points included in the second travel path with the motion characteristic information of the vehicle to determine whether the vehicle is able to operate along the second travel path. The operation of comparing the radius of curvature with the motion characteristic information of the vehicle to determine whether the vehicle is able to be operated along the second travel path will be described later with reference to FIG. 3.

At least one of the control center 110 or the vehicle control device 120 may identify that the vehicle is not able to be operated along the second travel path. The vehicle control device 120 may transmit a driving disturbance signal indicating that the vehicle is not able to be operated along the second travel path to the control center 110 based on the identification that the vehicle is not able to be operated along the second travel path.

The control center 110 that has received the driving disturbance signal indicating that the vehicle is not able to be operated along the second travel path from the vehicle control device 120 may change the locations of the second plurality of points included in the second travel path to generate a third travel path. For example, the operation of changing the locations of the second plurality of points may include an operation of changing the locations of the second plurality of points in a direction perpendicular to the second travel path.

The control center 110 may generate the third travel path by changing the locations of the second plurality of points. The control center 110 may transmit third information including the third travel path to the vehicle control device 120 based on the generation of the third travel path. The vehicle control device 120 that has received the third information may cause the vehicle to operate along the third travel path included in the third information.

As described above, while the vehicle is in operation along the first travel path, the vehicle control system 100 may generate the second travel path that is different from the first travel path and is for bypassing the external object to cause the vehicle to operate along the second travel path based on the identification of the external object that causes the vehicle to stop operating. The control center 110 of the vehicle control system 100 may generate the second travel path that is different from the first travel path and is for bypassing the external object, thereby preventing an operation time from being delayed by the external object.

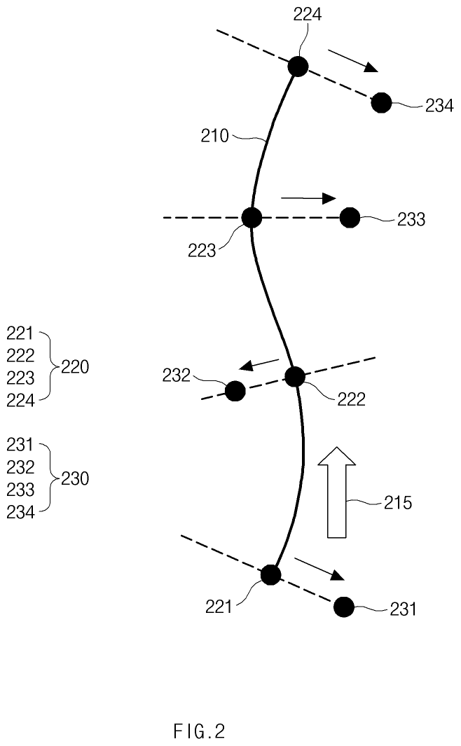

FIG. 2 shows an example of obtaining a second travel path by changing locations of a first plurality of points included in a first travel path.

A vehicle control system and a control center described in FIG. 2 may be components of the vehicle control system 100 in FIG. 1. The control center in FIG. 2 may include the control center 110 in FIG. 1. The vehicle control device in FIG. 2 may include the vehicle control device 120 in FIG. 1.

Referring to FIG. 2, the vehicle control device may cause the operation of the vehicle based on a first plurality of points 220 included in a first travel path 210. For example, the vehicle control device may cause the vehicle to operate at a location of each of the first plurality of points 220. For example, the vehicle control device may cause the vehicle to operate sequentially at a first point 221, a second point 222, a third point 223, and a fourth point 224 among the first plurality of points 220. Although the first point 221 to the fourth point 224 are shown in FIG. 2, the number of first plurality of points 220 is not limited thereto. For example, the first travel path 210 may include about 50 first plurality of points 220.

The vehicle control device may transmit the first information including at least one of the information on the vehicle or the information related to the travel of the vehicle, or any combination thereof to the control center based on identification of an external object that causes the vehicle to stop operating within the first travel path 210 by the vehicle operating along the first travel path 210 based on a travel direction 215.

The control center may change the first travel path 210 based on the reception of the first information. For example, the control center may obtain a second plurality of points 230 based on changing locations of the first plurality of points 220 included in the first travel path 210, and may obtain a second travel path based on the second plurality of points 230.

For example, the control center may change the locations of the first plurality of points 220. For example, the control center may move the locations of the first plurality of points 220 in a direction perpendicular to the first travel path 210.

The control center may obtain the second plurality of points 230 based on the movement of the locations of the first plurality of points 220 in the direction perpendicular to the first travel path 210.

For example, a first point 231 among the second plurality of points 230 may include a point obtained as the first point 221 among the first plurality of points 220 has moved in the direction perpendicular to the first travel path 210. For example, a second point 232 among the second plurality of points 230 may include a point obtained as the second point 222 among the first plurality of points 220 has moved in the direction perpendicular to the first travel path 210. For example, a third point 233 among the second plurality of points 230 may include a point obtained as the third point 223 among the first plurality of points 220 has moved in the direction perpendicular to the first travel path 210. For example, a fourth point 234 among the second plurality of points 230 may include a point obtained as the fourth point 224 among the first plurality of points 220 has moved in the direction perpendicular to the first travel path 210. However, aspects of the present disclosure are not limited thereto.

The control center may obtain the second plurality of points 230 obtained as at least some of the first plurality of points 220 have moved. The control center may generate the second travel path connecting the second plurality of points 230 to each other based on the obtaining of the second plurality of points 230. The control center may transmit the second information including the second travel path to the vehicle control device based on the obtaining of the second travel path. The second travel path may include the second plurality of points 230.

As described above, the control center may obtain the second plurality of points 230 based on the change of the locations of at least some of the first plurality of points 220. The control center may obtain the second travel path in which the second plurality of points 230 are sequentially connected to each other based on the obtaining of the second plurality of points 230. The control center may obtain the second travel path that is different from the first travel path 210 and is for bypassing the external object, thereby preventing the delay in the operation time of the vehicle caused by the external object.

Hereinafter, an example of the operation of determining whether the vehicle is able to be operated based on the second travel path will be described with reference to FIG. 3.

FIG. 3 shows an example of obtaining a radius of curvature to determine whether a vehicle is able to be operated.

A vehicle control device and a control center described in FIG. 3 may be included in the vehicle control system 100 in FIG. 1. The vehicle control device in FIG. 3 may include the vehicle control device 120 in FIG. 1. The control center in FIG. 3 may include the control center 110 in FIG. 1.

Referring to FIG. 3, at least one of the vehicle control device or the control center may identify a second travel path 310 obtained by changing the first travel path 210. At least one of the vehicle control device and the control center may identify a second plurality of points 320 included in the second travel path 310. For example, the second plurality of points 320 may include a set of locations where the vehicle controlled by the vehicle control device is to be sequentially operated.

At least one of the vehicle control device or the control center may identify three consecutive points among the second plurality of points 320 included in the second travel path 310. For example, at least one of the vehicle control device or the control center may identify a first point 321 from which the vehicle is to be sequentially operated, a second point 322 at which the vehicle is to be operated after the first point, and a third point 323 at which the vehicle is to be operated after the second point among the second plurality of points 320.

At least one of the vehicle control device or the control center may identify a first line segment 331 connecting the first point 321 and the second point 322 to each other. At least one of the vehicle control device or the control center may identify a second line segment 332 connecting the second point 322 and the third point 323 to each other. The first line segment 331 and the second line segment 332 may be expressed as straight lines and may include line segments connecting two consecutive points to each other.

At least one of the vehicle control device or the control center may identify a first perpendicular bisector 341 of the first line segment 331. At least one of the vehicle control device or the control center may identify a second perpendicular bisector 342 of the second line segment 332.

For example, the first perpendicular bisector 341 of the first line segment 331 may include a straight line perpendicular to the first line segment 331 from a middle point of the first line segment 331. For example, the second perpendicular bisector 342 of the second line segment 332 may include a straight line perpendicular to the second line segment 332 from a middle point of the second line segment 332.

At least one of the vehicle control device or the control center may identify an intersection 350 of the first perpendicular bisector 341 and the second perpendicular bisector 342. For example, the intersection 350 of the first perpendicular bisector 341 and the second perpendicular bisector 342 may include a center of a circle of which radius is a line segment connecting the intersection 350 with the second point 322.

At least one of the vehicle control device or the control center may identify a radius of curvature 360 based on a distance between the second point 322 and the intersection 350 formed by the first perpendicular bisector 341 and the second perpendicular bisector 342.

At least one of the vehicle control device or the control center may compare the motion characteristic information of the vehicle with the radius of curvature 360 based on the identification of the radius of curvature 360. For example, the motion characteristic information of the vehicle may be included in the first information transmitted from the vehicle control device to the control center. At least one of the vehicle control device or the control center may determine whether the vehicle is able to be operated along the second travel path 310 formed by the second plurality of points 320 based on the comparison between the motion characteristic information and the radius of curvature 360.

For example, at least one of the vehicle control device or the control center may identify that the radius of curvature 360 is smaller than the minimum turning radius of the vehicle in the motion characteristic information included in the first information. At least one of the vehicle control device or the control center may identify that the vehicle is not able to be operated along the second travel path 310 based on the radius of curvature 360 being smaller than the minimum turning radius of the vehicle.

For another example, at least one of the vehicle control device or the control center may identify that the radius of curvature 360 is greater than the minimum turning radius of the vehicle in the motion characteristic information included in the first information. At least one of the vehicle control device or the control center may identify that the vehicle is able to be operated along the second travel path 310 based on the radius of curvature 360 being greater than the minimum turning radius of the vehicle.

If the vehicle is able to be operated along the second travel path 310, the control center may transmit the second information including the second travel path to the vehicle control device.

If the vehicle is not able to be operated along the second travel path 310, the control center may generate a third travel path by changing locations of the second plurality of points 320. The operation of changing the locations of the second plurality of points 320 may be performed via substantially the same process as the operation of changing the locations of the first plurality of points.

As described above, at least one of the vehicle control device or the control center may identify whether the vehicle is able to be operated along a second travel path 410 based on the radius of curvature 360 and the minimum turning radius of the vehicle. At least one of the vehicle control device or the control center may determine whether the vehicle is able to be operated along the second travel path 410 and operate the vehicle based on the identified operable state, thereby improving stability of the vehicle.

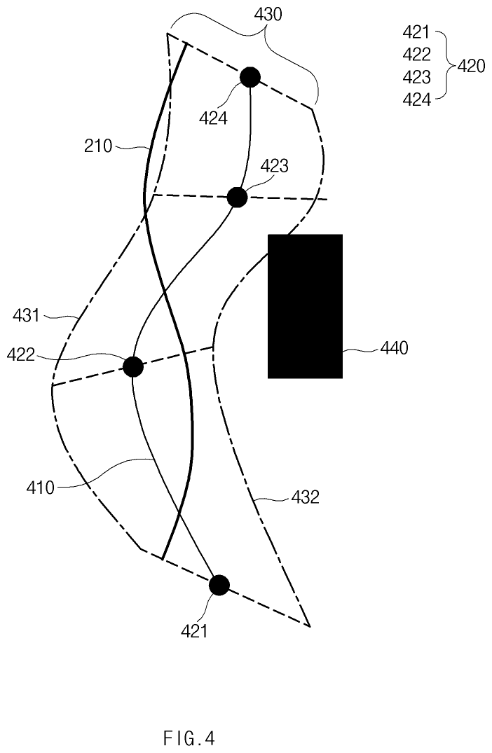

Hereinafter, an example of the operation of identifying whether the vehicle is able to be operated based on the second travel path will be described with reference to FIG. 4.

FIG. 4 shows an example of identifying a possibility of collision between a vehicle with an external object.

A vehicle control device and a control center described in FIG. 4 may be included in the vehicle control system 100 in FIG. 1. The vehicle control device in FIG. 4 may include the vehicle control device 120 in FIG. 1. The control center in FIG. 4 may include the control center 110 in FIG. 1.

Referring to FIG. 4, at least one of the vehicle control device or the control center may obtain the second travel path 410 in a state in which the vehicle is not able to be operated along the first travel path 210. The second travel path may include a second plurality of points 420. The second plurality of points 420 may include points obtained as at least some of the first plurality of points included in the first travel path 210 have been moved.

At least one of the vehicle control device or the control center may identify the specification of the vehicle included in the information on the vehicle. For example, the specification of the vehicle may include the width of the vehicle. At least one of the vehicle control device or the control center may obtain a virtual travel lane 430 based on applying a specified percentage to the width of the vehicle in a direction perpendicular to the second travel path 410. For example, the specified percentage may include approximately 150 percent (%). for example, the specified percentage may include a specified offset.

For example, at least one of the vehicle control device or the control center may apply half of the specified percentage to the width of the vehicle in a first direction perpendicular to the second travel path 410 to obtain a first line 431. At least one of the vehicle control device or the control center may apply half of the specified percentage to the width of the vehicle in a second direction opposite to the first direction to obtain a second line 432. At least one of the vehicle control device or the control center may obtain the virtual travel lane 430 based on the first line 431 and the second line 432.

At least one of the vehicle control device or the control center may identify an external object 440 within the virtual travel lane 430 based on the identification of the virtual travel lane 430. For example, at least one of the vehicle control device or the control center may identify a possibility of collision between the external object 440 and the vehicle based on whether the external object 440 is identified within the virtual travel lane 430.

The vehicle control device may transmit a signal indicating that the vehicle is not able to be operated along the second travel. path 410 to the control center based on the identification that there is the possibility of collision between the external object 440 and the vehicle. The control center may generate a third travel path different from the second travel path 410 based on the reception of the signal indicating that the vehicle is not able to be operated along the second travel path 410.

The control center may identify that there is the possibility of collision between the external object 440 and the vehicle, based on the identification of the external object 440 within the virtual travel lane 430. The control center may generate the third travel path by changing locations of the second plurality of points 420 based on the identification that there is the possibility of collision between the external object 440 and the vehicle. Based on the generation of the third travel path, the control center may transmit the third information including the third travel path to the vehicle control device.

At least one of the vehicle control device or the control center may determine whether at least portions of the first line 431 and the second line 432 overlap the external object 440.

At least one of the vehicle control device or the control center may identify that the vehicle is not able to be operated along the second travel path 410 based on the at least the portions of the first line 431 and the second line 432 overlapping the external object 440. Based on the identification that the vehicle is not able to be operated along the second travel path 410, the vehicle control device may transmit a signal requesting the third travel path different from the second travel path 410 to the control center. The control center may transmit the third information including the third travel path obtained by changing the second travel path 410 to the vehicle control device in response to the signal requesting the third travel path.

At least one of the vehicle control device or the control center may identify that the vehicle is able to be operated along the second travel path 410 based on the at least the portions of the first line 431 and the second line 432 and the external object 430 not overlapping the external object 440.

In response to the identification that the vehicle is able to be operated along the second travel path 410, the vehicle control device may cause the vehicle to be operated along the second travel path 410.

The control center may transmit the second information including the second travel path 410 to the vehicle control device based on the identification that the vehicle is able to be operated along the second travel path 410.

As described above, at least one of the vehicle control device or the control center may determine whether the external object is included in the second travel path. At least one of the vehicle control device or the control center may reduce a possibility of an accident by operating the vehicle along the second travel path when the external object is not included in the second travel path.

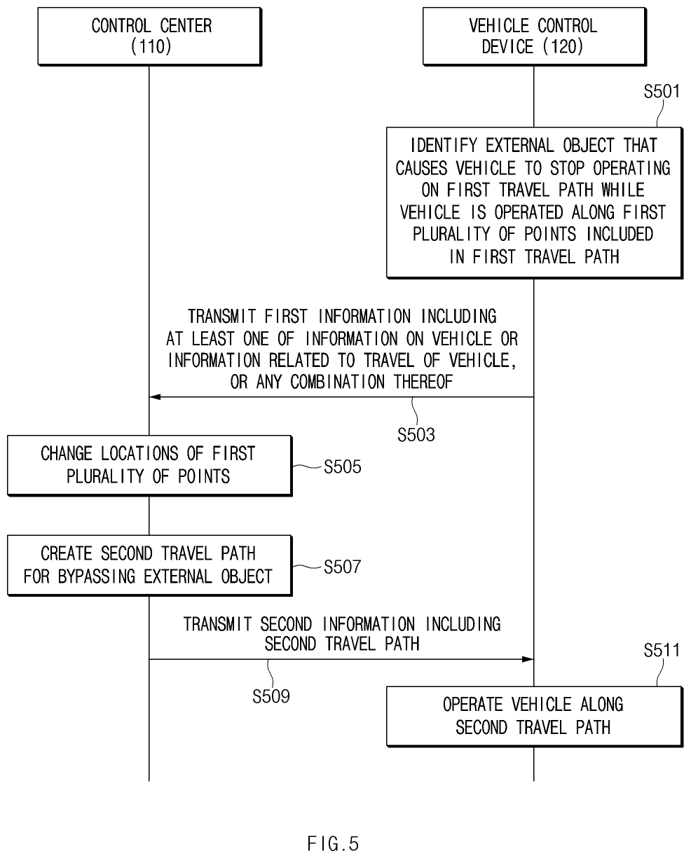

FIG. 5 shows an example of a signal flow diagram of a control center and a vehicle control device.

A vehicle control system described in FIG. 5 may include the vehicle control system 100 in FIG. 1. The control center 110 in FIG. 5 may include the control center 110 in FIG. 1. The vehicle control device 120 in FIG. 5 may include the vehicle control device 120 in FIG. 1.

At least one of operations in FIG. 5 may be performed by the control center 110 in FIG. 1 or the vehicle control device 120 in FIG. 1. The operations in FIG. 5 may be performed sequentially, but may not be necessarily performed sequentially. For example, an order of each of the operations may be changed, or at least two operations may be performed in parallel.

Referring to FIG. 5, in operation S501, the vehicle control device 120 included in the vehicle control system may identify the external object that causes the vehicle to stop operating on the first travel path while the vehicle is operated along the first plurality of points included in the first travel path. For example, the vehicle control device 120 may identify the external object that causes the operation of the vehicle to be stopped on the first travel path using the imaging device included in the vehicle.

In operation S503, the vehicle control device 120 included in the vehicle control system may transmit the first information including at least one of the information on the vehicle or the information related to the travel of the vehicle, or any combination thereof to the control center 110.

For example, while the vehicle is operated along the first plurality of points included in the first travel path, the vehicle control device 120 may transmit the first information including at least one of the information on the vehicle or the information related to the travel of the vehicle, or any combination thereof based on the identification of the external object that causes the operation of the vehicle to be stopped within the first travel path.

For example, the information on the vehicle may include at least one of the specification of the vehicle or the motion characteristic information of the vehicle, or any combination thereof.

For example, the information related to the travel of the vehicle may include at least one of the surrounding environment of the vehicle, the location of the vehicle, the speed of the vehicle, the first travel path, the first plurality of points included in the first travel path, or the signal indicating that the vehicle is not able to be operated along the first travel path, or any combination thereof.

In operation S505, the control center 110 included in the vehicle control system may change the locations of the first plurality of points. For example, the control center 110 may change the locations of the first plurality of points included in the first travel path based on the reception of the first information from the vehicle control device 120.

For example, the control center 110 may obtain the second plurality of points by changing the locations of the first plurality of points in the direction perpendicular to the first travel path.

In operation S507, the control center 110 included in the vehicle control system may generate the second travel path for bypassing the external object. For example, the control center 110 may obtain the second travel path that sequentially connects the second plurality of points to each other based on the obtaining of the second plurality of points.

In operation S509, the control center 110 included in the vehicle control system may transmit the second information including the second travel path to the vehicle control device 120. For example, the control center 110 may transmit the second information including the second travel path to the vehicle control device 120 based on the generation of the second travel path for bypassing the external object.

In operation S511, the vehicle control device 120 included in the vehicle control system may operate the vehicle along the second travel path. For example, the vehicle control device 120 may control the vehicle to operate along the second travel path. For another example, the vehicle control device 120 may cause the vehicle to operate along the second travel path using at least one of a hardware component or a software component, or any combination thereof different from the vehicle control device 120.

As described above, the vehicle control system may operate the vehicle using the second travel path in which the vehicle bypasses the external object. The vehicle control system may reduce the operation time delayed by the external object by operating the vehicle using the second travel path that bypasses the external object.

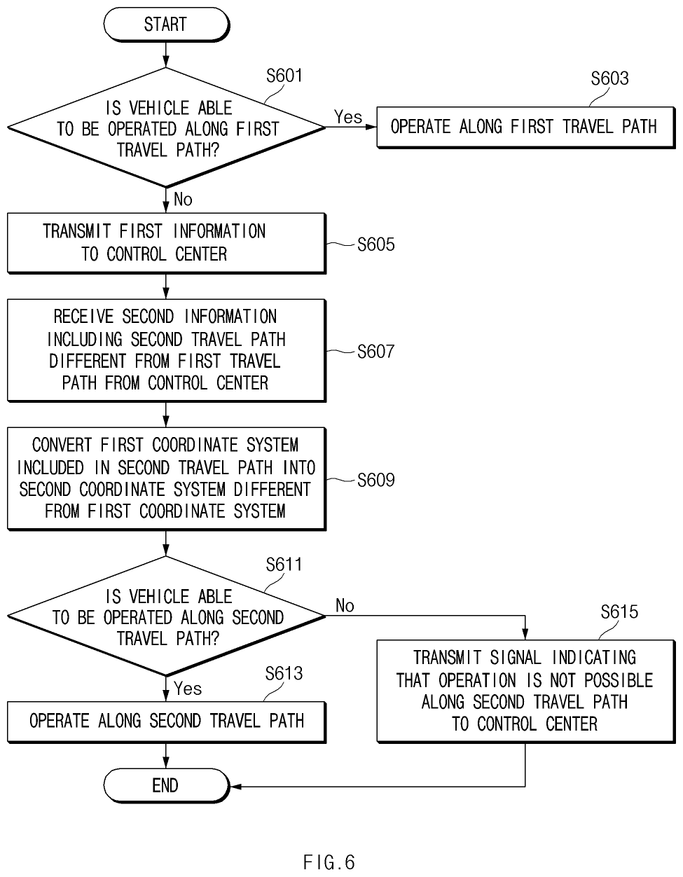

FIG. 6 shows an example of a flowchart related to operations of a vehicle control device.

A vehicle control device and a control center described in FIG. 6 may be included in the vehicle control system 100 in FIG. 1. The vehicle control device in FIG. 6 may include the vehicle control device 120 in FIG. 1. The control center in FIG. 6 may include the control center 110 in FIG. 1.

At least one of the operations in FIG. 6 may be performed by the control center 110 in FIG. 1 or the vehicle control device 120 in FIG. 1. The operations in FIG. 6 may be performed sequentially, but may not be necessarily performed sequentially. For example, an order of each of the operations may be changed, or at least two operations may be performed in parallel.

Referring to FIG. 6, in operation S601, the vehicle control device may determine whether the vehicle is able to be operated along the first travel path. For example, the vehicle control device may perform different operations depending on whether the vehicle is able to be operated along the first travel path.

For example, while the vehicle is operated along the first travel path, the vehicle control device may identify the external object that causes the operation of the vehicle to be stopped. For example, when the external object exists in a state overlapping at least partially with the first travel path, the external object may cause the operation of the vehicle to be stopped.

The vehicle control device may be in communication with the control center when the operation is infeasible (e.g., impossible) along the first travel path, and may continue the operation of the vehicle along the first travel path when the operation is possible along the first travel path. Alternatively, the vehicle control device may cause the vehicle to operate along the first travel path using at least one of the hardware component or the software component, or any combination thereof included in the vehicle when the operation is possible along the first travel path.

When the operation is possible along the first travel path (Yes in operation S601), in operation S603, the vehicle control device included in the vehicle control system may operate the vehicle along the first travel path.

When the operation is infeasible (e.g., not possible) along the first travel path (No in operation S601), in operation S605, the vehicle control device may transmit the first information to the control center. For example, the vehicle control device may transmit the first information including at least one of the information on the vehicle or the information related to the travel of the vehicle, or any combination thereof.

For example, the information on the vehicle may include information related to a physical element of the vehicle. For example, the information on the vehicle may include the specification of the vehicle and the motion characteristic information of the vehicle. For example, the motion characteristic information of the vehicle may include at least one of the minimum turning radius, a maximum speed, or a braking force of the vehicle, or any combination thereof.

For example, the information related to the travel of the vehicle may include at least one of the surrounding environment of the vehicle, the location of the vehicle, the speed of the vehicle, the first travel path, the first plurality of points included in the first travel path, or the signal indicating that the vehicle is not able to be operated along the first travel path, or any combination thereof.

In operation S607, the vehicle control device may receive the second information including the second travel path different from the first travel path from the control center.

For example, the vehicle control device may receive the second information including the second travel path different from the first travel path from the control center that has responded to the first information. For example, the second travel path may be obtained based on the second plurality of points obtained by changing the locations of at least some of the first plurality of points included in the first information.

In operation S609, the vehicle control device may convert the first coordinate system included in the second travel path into the second coordinate system different from the first coordinate system.

For example, the first coordinate system may include at least one of the WGS 84, the global coordinate system, or the world map coordinate system, or any combination thereof. For example, the second coordinate system may include the local coordinate system. However, aspects of the present disclosure are not limited thereto.

In operation $611, the vehicle control device may determine whether the vehicle is able to be operated along the second travel path. For example, the vehicle control device may determine whether the vehicle is able to be operated along the second travel path converted to the second coordinate system different from the first coordinate system.

The vehicle control device may determine whether the vehicle is able to be operated along the second travel path based on the comparison between the minimum turning radius of the vehicle with the radius of curvature obtained using at least three points among the second plurality of points included in the second travel path. For example, the at least three points among the second plurality of points may include the three consecutive points in the second travel path. Operations for obtaining the radius of curvature may refer to the operations in FIG. 3.

For example, when the radius of curvature obtained using the at least three points among the second plurality of points is smaller than the minimum turning radius of the vehicle, the vehicle control device may identify that the vehicle is not able to be operated along the second travel path. For example, when the radius of curvature obtained by using the at least three points among the second plurality of points is greater than the minimum turning radius of the vehicle, the vehicle control device may identify that the vehicle is able to be operated along the second travel path.

The vehicle control device may determine whether the vehicle is able to be operated along the second travel path based on whether at least a portion of the second travel path overlaps the external object. For example, if the at least the portion of the second travel path overlaps the external object, the vehicle control device may identify that the vehicle is not able to be operated along the second travel path. For example, if the at least the portion of the second travel path does not overlap the external object, the vehicle control device may identify that the vehicle is able to be operated along the second travel path.

If the vehicle is able to be operated along the second travel path (Yes in operation S611), in operation S613, the vehicle control device may operate the vehicle along the second travel path.

For example, the vehicle control device may operate the vehicle along the second travel path for bypassing the external object. The vehicle control device may operate the vehicle along the second travel path based on the identification that the vehicle is able to be operated along the second travel path.

If the vehicle is not able to be operated along the second travel path (No in operation S611), in operation S615, the vehicle control device may transmit the driving disturbance signal indicating that the operation is infeasible (e.g., not possible) along the second travel path to the control center. Alternatively or additionally, the vehicle control device may transmit the first information including the driving disturbance signal to the control center.

For example, the vehicle control device may transmit, to the control center, a signal requesting transmission of the third travel path different from the second travel path along with transmitting the first information.

As described above, the vehicle control device may receive the second information including the second travel path for bypassing the external object from the control center based on the identification of the external object within the first travel path. The vehicle control device may prevent the accident and reduce the operation time delayed by the external object by bypassing the external object using the second travel path.

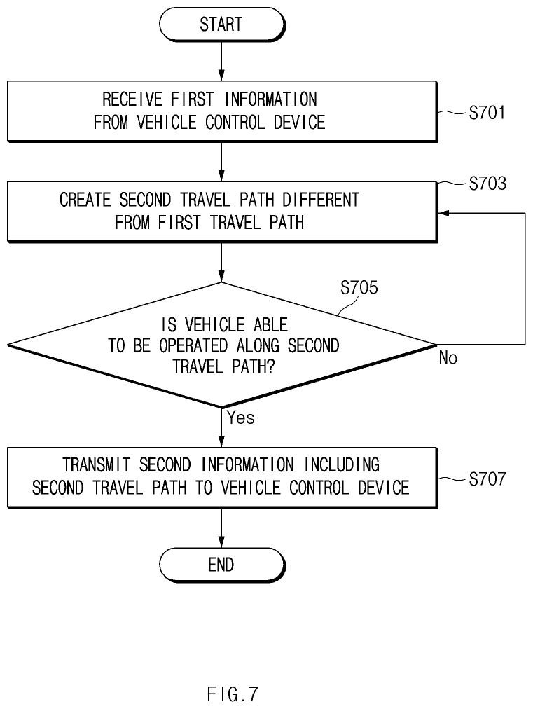

FIG. 7 shows an example of a flowchart related to operations of a control center.

A vehicle control device and a control center described in FIG. 7 may be included in the vehicle control system 100 in FIG. 1. The vehicle control device in FIG. 7 may include the vehicle control device 120 in FIG. 1. The control center in FIG. 7 may include the control center 110 in FIG. 1.

At least one of the operations in FIG. 7 may be performed by the control center 110 in FIG. 1 or the vehicle control device 120 in FIG. 1. The operations in FIG. 7 may be performed sequentially, but may not be necessarily performed sequentially. For example, an order of each of the operations may be changed, or at least two operations may be performed in parallel.

Referring to FIG. 7, in operation S701, the control center may receive the first information from the vehicle control device. For example, the control center may receive the first information including at least one of the information on the vehicle or the information: related to the travel of the vehicle, or any combination thereof from the vehicle control device.

For example, the control center may identify that the vehicle including the vehicle control device is not able to be operated along the first travel path, based on the reception of the first information from the vehicle control device.

In operation S703, the control center may generate the second travel path different from the first travel path. For example, the control center may generate the second travel path based on the second plurality of points obtained by changing the locations of at least some of the first plurality of points included in the first travel path. For example, the control center may change the locations of the at least some of the first plurality of points included in the first travel path to bypass the external object. The control center may generate the second travel path based on the second plurality of points obtained by changing the locations of the at least some of the first plurality of points.

In operation S705, the control center may determine whether the vehicle is able to be operated along the second travel path.

The control center may determine whether the vehicle is able to be operated along the second travel path based on the comparison between the minimum turning radius of the vehicle and the radius of curvature obtained using the at least three points among the second plurality of points included in the second travel path. Operations for obtaining the radius of curvature may refer to the operations in FIG. 3.

For example, if the radius of curvature obtained using the at least three points among the second plurality of points is smaller than the minimum turning radius of the vehicle, the control center may identify that the vehicle is not able to be operated along the second travel path. For example, if the radius of curvature obtained using the at least three points among the second plurality of points is greater than the minimum turning radius of the vehicle, the control center may identify that the vehicle is able to be operated along the second travel path.

The control center may determine whether the vehicle is able to be operated along the second travel path based on whether the at least the portion of the second travel path overlaps the external object. For example, if the at least the portion of the second travel path overlaps the external object, the control center may identify that the vehicle is not able to be operated along the second travel path. For example, if the at least the portion of the second travel path does not overlap the external object, the control center may identify that the vehicle is able to be operated along the second travel path.

If the vehicle is able to be operated along the second travel path (Yes in operation S705), in operation S707, the control center may transmit the second information including the second travel path to the vehicle control device. For example, the second information may include the second travel path based on the first coordinate system. For example, the second information may include the second travel path including the second plurality of points.

If the vehicle is not able to be operated along the second travel path (No in operation S705), in operation S703, the control center may generate the travel path. For example, the control center may generate the third travel path different from the first travel path and the second travel path based on the identification that the vehicle is not able to be operated along the second travel path. Although ‘generate second travel path different from first travel path’ is shown in operation S703 in FIG. 7, this may be classified into ‘first’ and ‘second’ to indicate that the first travel path and the second travel path are different from each other.

As described above, if the vehicle is not able to be operated along the first travel path, the control center may generate the second travel path different from the first travel path, and transmit the second information including the second travel path to the vehicle control device. The control center may reduce the operation time of the vehicle delayed by the external object and prevent the collision between the external object and the vehicle by transmitting the second information including the second travel path to the vehicle control device.

The control center described herein may be (or may include) a device associated with a control center. The device (e.g., a server, a relay, etc.) may be associated with a control center and communicate with the vehicle via wireless communication. The device may have granted with an authority and policy (e.g., for generating an autonomous driving path) that are not available for the autonomous driving system of the vehicle. For example, the vehicle may not generate an alternative autonomous driving path that causes the vehicle to violate traffic laws and driving rules (e.g. crossing the center lane of a road, increasing the vehicle speed over a specific speed, etc.) while the device associated with the control center may generate such an alternative autonomous driving path that causes the vehicle to violate traffic laws and driving rules based on additional traffic data (e.g., additional traffic information regarding other vehicles and obstacles).

According to an aspect of the present disclosure, a system for controlling a vehicle may include a vehicle control device included in the vehicle, and a control center. The vehicle control device may transmit first information including at least one of information on the vehicle or information related to travel of the vehicle, or any combination to the control center based on identifying an external object causing an operation of the vehicle to be stopped within a first travel path while the vehicle is operated along the first travel path. The control center may change the first travel path to generate a second travel path based on reception of the first information, and transmits second information including the second travel path to the vehicle control device based on the generation of the second travel path.

In one implementation, the control center may generate the second travel path based on a second plurality of points obtained by changing locations of a first plurality of points included in the first travel path in a direction perpendicular to the first travel path.

In one implementation, at least one of the vehicle control device or the control center may identify a first point where the vehicle is to be operated, a second point where the vehicle is to be operated after the first point, and a third point where the vehicle is to be operated after the second point among a second plurality of points included in the second travel path, identify a radius of curvature based on at least one of the first point, the second point, or the third point, or any combination, and determine whether the vehicle is able to be operated along the second travel path based on at least one of the radius of curvature or motion characteristic information of the vehicle included in the first information, or any combination.

In one implementation, the control center may generate a third travel path by changing locations of the second plurality of points based on identifying that the radius of curvature is smaller than a minimum turning radius of the vehicle in the information on the vehicle included in the first information.

In one implementation, the control center may transmit the second information including the second travel path including the second plurality of points to the vehicle control device based on identifying that the radius of curvature is greater than a minimum turning radius of the vehicle in the information on the vehicle included in the first information.

In one implementation, at least one of the control center and the vehicle control device may obtain a virtual travel lane based on applying a specified offset to a width of the vehicle included in the information on the vehicle, and identify a possibility of collision between the external object and the vehicle based on whether the external object is identified within the virtual travel lane.

In one implementation, the control center may identify that there is the possibility of collision between the external object and the vehicle based on the identification of the external object within the virtual travel lane, generate a third travel path by changing locations of a second plurality of points based on the identification that there is the possibility of collision between the external object and the vehicle, and transmit third information including the third travel path to the vehicle control device.

In one implementation, the control center may identify that there is no possibility of collision between the external object and the vehicle based on the external object not being identified within the virtual travel lane, and transmit the second information including the second travel path to the vehicle control device based on the identification that there is no possibility of collision between the external object and the vehicle.

In one implementation, the vehicle control device may compare a first coordinate system included in the second travel path received from the control center with a second coordinate system used in the vehicle control device, operate the vehicle along the second travel path based on a same the first coordinate system and the second coordinate system, convert the first coordinate system included in the second travel path into the second coordinate system, and operate the vehicle along the second travel path including the second coordinate system.

In one implementation, the vehicle control device may transmit, to the control center, a driving disturbance signal indicating that the vehicle is not able to be operated along the second travel path, based on identifying that the vehicle is not able to be operated along the second travel path. The control center may generate a third travel path by changing locations of the second plurality of points included in the second travel path based on reception of the driving disturbance signal, and transmit third information including the third travel path to the vehicle control device based on the generation of the third travel path.

In one implementation, the information on the vehicle may include at least one of a specification of the vehicle or motion characteristic information of the vehicle, or any combination. The information related to the travel of the vehicle may include at least one of a surrounding environment of the vehicle, a location of the vehicle, a speed of the vehicle, the first travel path, a first plurality of points, or a signal indicating that the vehicle is not able to be operated along the first travel path, or any combination.

According to another aspect of the present disclosure, a method for controlling a vehicle includes transmitting first information including at least one of information on the vehicle or information related to travel of the vehicle, or any combination to a control center based on identifying an external object causing an operation of the vehicle to be stopped within a first travel path while the vehicle is operated along the first travel path, changing the first travel path to generate a second travel path based on reception of the first information, and transmitting second information including the second travel path to a vehicle control device included in the vehicle based on the generation of the second travel path.

In one implementation, the method may further include generating the second travel path based on a second plurality of points obtained by changing locations of a first plurality of points included in the first travel path in a direction perpendicular to the first travel path.

In one implementation, the method may further include identifying a first point where the vehicle is to be operated, a second point where the vehicle is to be operated after the first point, and a third point where the vehicle is to be operated after the second point among a second plurality of points included in the second travel path, identifying a radius of curvature based on at least one of the first point, the second point, or the third point, or any combination, and determining whether the vehicle is able to be operated along the second travel path based on at least one of the radius of curvature or motion characteristic information of the vehicle included in the first information, or any combination.

In one implementation, the method may further include generating a third travel path by changing locations of the second plurality of points based on identifying that the radius of curvature is smaller than a minimum turning radius of the vehicle in the information on the vehicle included in the first information.

In one implementation, the method may further include transmitting the second information including the second travel path including the second plurality of points to the vehicle control device based on identifying that the radius of curvature is greater than a minimum turning radius of the vehicle in the information on the vehicle included in the first information.

In one implementation, the method may further include obtaining a virtual travel lane based on applying a specified offset to a width of the vehicle included in the information on the vehicle, and identifying a possibility of collision between the external object and the vehicle based on whether the external object is identified within the virtual travel lane.

In one implementation, the method may further include identifying that there is the possibility of collision between the external object and the vehicle based on the identification of the external object within the virtual travel lane, generating a third travel path by changing locations of a second plurality of points based on the identification that there is the possibility of collision between the external object and the vehicle, and transmitting third information including the third travel path to the vehicle control device.

In one implementation, the method may further include identifying that there is no possibility of collision between the external object and the vehicle based on the external object not being identified within the virtual travel lane, and transmitting the second information including the second travel path to the vehicle control device based on the identification that there is no possibility of collision between the external object and the vehicle.

In one implementation, the method may further include comparing a first coordinate system included in the second travel path received from the control center with a second coordinate system used in the vehicle control device, operating the vehicle along the second travel path based on a same the first coordinate system and the second coordinate system, converting the first coordinate system included in the second travel path into the second coordinate system, based on a difference the first coordinate system with the second coordinate system, and operating the vehicle along the second travel path including the second coordinate system.

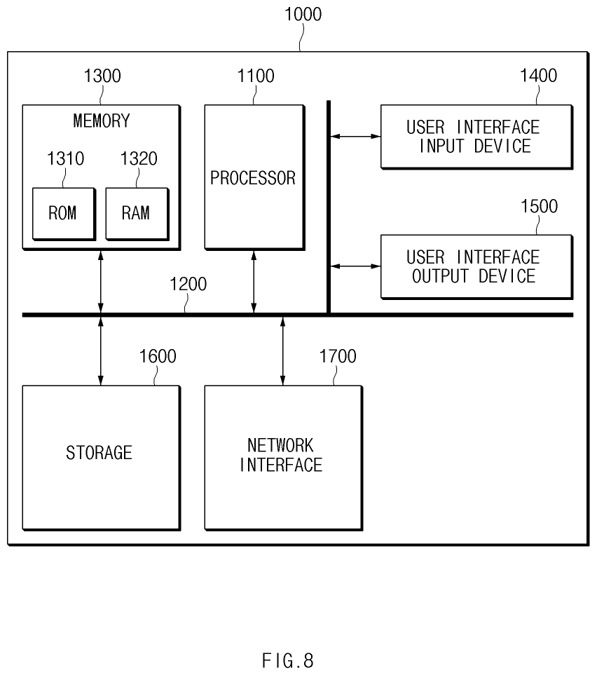

FIG. 8 illustrates a computing system according to an embodiment of the present disclosure.

With reference to FIG. 8, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, and a CD-ROM.

The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, various features disclosed in the present disclosure are not intended to limit the technical idea of the present disclosure but to illustrate the present disclosure, and the scope of the technical idea of the present disclosure is not limited by the illustrated examples. The scope of the present disclosure should be construed as being covered by the scope of the appended claims, and all technical ideas falling within the scope of the claims should be construed as being included in the scope of the present disclosure.

One or more aspects of the present disclosure may cause the operation of the vehicle along the second travel path different from the first travel path based on the identifying of the external object that causes the operation of the vehicle to be stopped while the vehicle is operating along the first travel path.

In addition, one or more aspects of the present disclosure may provide the travel path where the vehicle is operated by bypassing the obstacle when the center line invading travel is necessary because of the obstacle on the single-lane one-way road or the dual-lane two-way road.

In addition, one or more aspects of the present disclosure may improve the stability of the vehicle by providing the new travel path to bypass the object located in front of the vehicle when the distance between the vehicle and the object located in front of the vehicle is small.

In addition, various effects identified directly or indirectly through the present document may be provided.

Hereinabove, although the present disclosure has been described with reference to exemplary embodiment(s) and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle comprising:
a communication interface;
a vehicle control device; and
a controller,
wherein the controller is configured to:
transmit, to a device via the communication interface, first information indicating a first autonomous driving path of the vehicle;
receive, based on an external object causing an adjustment of the first autonomous driving path while the vehicle is driving along the first autonomous driving path, second information indicating a second autonomous driving path, wherein the second autonomous driving path is adjusted based on the first autonomous driving path; and
based on a determination of whether the second autonomous driving path is feasible for an autonomous driving adjustment of the vehicle:
perform, by the vehicle control device, the autonomous driving adjustment of the vehicle; or
transmit, to the device, information indicating that the second autonomous driving path is infeasible for the vehicle.

2. The vehicle of claim 1, wherein the controller is configured to:
after receiving the second information, generate the second autonomous driving path based on a plurality of changed points obtained by changing locations of a first plurality of points included in the first autonomous driving path, wherein a direction of the changing locations of the first plurality of points is perpendicular to a direction of the first autonomous driving path.

3. The vehicle of claim 1, wherein the controller is configured to:
identify, among a plurality of changed points included in the second autonomous driving path, a first changed point where the vehicle is to be operated, a second changed point where the vehicle is to be operated after the first changed point, and a third changed point where the vehicle is to be operated after the second changed point, wherein the plurality of changed points are obtained by changing locations of a first plurality of points included in the first autonomous driving path;
identify a radius of curvature based on at least one of: the first changed point, the second changed point, or the third changed point; and
determine whether the vehicle is able to be operated along the second autonomous driving path based on at least one of: the radius of curvature, or motion characteristic information of the vehicle.

4. The vehicle of claim 3, wherein at least one of the controller or the vehicle control device is configured to:
generate a third autonomous driving path by changing locations of the plurality of changed points based on the radius of curvature being smaller than a minimum turning radius of the vehicle.

5. The vehicle of claim 3, wherein the controller is configured to:
receive the second information by receiving, by the vehicle control device, the second information indicating, the second autonomous driving path that comprises the plurality of changed points, based on the radius of curvature being greater than a minimum turning radius of the vehicle.

6. The vehicle of claim 1, wherein at least one of the controller or the vehicle control device is configured to:
obtain a virtual travel lane based on a specified offset applied to a width of the vehicle; and
determine a possibility of collision between the external object and the vehicle based on whether the external object is identified within the virtual travel lane.

7. The vehicle of claim 6, wherein the controller is configured to:
determine, based on the possibility of collision between the external object and the vehicle, a third autonomous driving path by changing locations of a plurality of changed points, wherein the plurality of changed points are obtained by changing locations of a first plurality of points included in the first autonomous driving path; and
transmit, to the vehicle control device, third information indicating the third autonomous driving path.

8. The vehicle of claim 6, wherein the controller is configured to:
transmit, to the vehicle control device and based on the external object not being identified within the virtual travel lane, the second information indicating the second autonomous driving path.

9. The vehicle of claim 1, wherein at least one of the vehicle control device or the controller is configured to:
compare a first coordinate system associated with the second autonomous driving path with a second coordinate system associated with the vehicle control device,
control, based on the first coordinate system and the second coordinate system being the same, the vehicle along the second autonomous driving path, and
based on a difference between the first coordinate system and the second coordinate system:
convert the first coordinate system associated with the second autonomous driving path, and
control, based on converting the first coordinate system, the vehicle along the second autonomous driving path.

10. The vehicle of claim 3, wherein at least one of the vehicle control device or the controller is configured to:
transmit, to the device that is associated with a control center, a driving disturbance signal indicating that the vehicle is not able to be operated along the second autonomous driving path, and
receive, based on the driving disturbance signal, a third autonomous driving path obtained by changing locations of the plurality of changed points.

11. The vehicle of claim 1, wherein the first information comprises information of the vehicle comprising at least one of: a specification of the vehicle, or motion characteristic information of the vehicle, and
wherein the first information comprises information related to driving of the vehicle comprising at least one of: a surrounding environment of the vehicle, a location of the vehicle, a speed of the vehicle, the first autonomous driving path, a first plurality of points included in the first autonomous driving path, or a signal indicating that the vehicle is not able to be operated along the first autonomous driving path.

12. A method comprising:
transmitting, from a vehicle to a device, first information indicating a first autonomous driving path of the vehicle;
receiving, by the vehicle and based on an external object causing an adjustment of the first autonomous driving path while the vehicle is driving along the first autonomous driving path, second information indicating a second autonomous driving path, wherein the second autonomous driving path is adjusted based on the first autonomous driving path; and
based on a determination of whether the second autonomous driving path is feasible for an autonomous driving adjustment of the vehicle:
performing the autonomous driving adjustment of the vehicle; or
transmitting, to the device, information indicating that the second autonomous driving path is infeasible for the vehicle.

13. The method of claim 12, further comprising:
generating the second autonomous driving path based on a plurality of changed points obtained by changing locations of a first plurality of points included in the first autonomous driving path.

14. The method of claim 12, further comprising:
identifying, among a plurality of changed points included in the second autonomous driving path, a first changed point where the vehicle is to be operated, a second changed point where the vehicle is to be operated after the first changed point, and a third changed point where the vehicle is to be operated after the second changed point, wherein the plurality of changed points are obtained by changing locations of a first plurality of points included in the first autonomous driving path;
identifying a radius of curvature based on at least one of: the first changed point, the second changed point, or the third changed point; and
determining whether the vehicle is able to be operated along the second autonomous driving path based on at least one of: the radius of curvature, or motion characteristic information of the vehicle.

15. The method of claim 14, further comprising:
generating a third autonomous driving path by changing locations of the plurality of changed points based on the radius of curvature being smaller than a minimum turning radius of the vehicle.

16. The method of claim 14, wherein:
the receiving the second information comprises receiving, by a vehicle control device of the vehicle, the second information, indicating the second autonomous driving path that comprises the plurality of changed points, based on the radius of curvature being greater than a minimum turning radius of the vehicle.

17. The method of claim 12, further comprising:
obtaining a virtual travel lane based on a specified offset applied to a width of the vehicle; and
determining a possibility of collision between the external object and the vehicle based on whether the external object is identified within the virtual travel lane.

18. The method of claim 17, further comprising:
determining, based on the possibility of collision between the external object and the vehicle, a third autonomous driving path by changing locations of a plurality of changed points, wherein the plurality of changed points are obtained by changing locations of a first plurality of points included in the first autonomous driving path; and
transmitting, to a vehicle control device of the vehicle, third information indicating the third autonomous driving path.

19. The method of claim 17, further comprising:
transmitting, to a vehicle control device of the vehicle and based on the external object not being identified within the virtual travel lane, the second information indicating the second autonomous driving path.

20. The method of claim 12, further comprising:
comparing a first coordinate system associated with the second autonomous driving path with a second coordinate system associated with a vehicle control device of the vehicle;
converting, based on a difference between the first coordinate system and the second coordinate system, the first coordinate system associated with the second autonomous driving path; and
controlling, based on the converting, the vehicle along the second autonomous driving path.
